(19) United States
(12) Patent Application Publication
(10) Pub. No.: US 2013/0328836 A1
(43) Pub. Date: Dec. 12, 2013

(54) INFORMATION INPUT APPARATUS USING ULTRASONIC SIGNAL

(71) Applicant: PNF Co., Ltd., Seongnam-si (KR)

(72) Inventor: Jae Jun LEE, Seoul (KR)

(21) Appl. No.: 13/914,012

(22) Filed: Jun. 10, 2013

(30) Foreign Application Priority Data
Jun. 11, 2012 (KR) 10-2012-0061950

(51) Int. Cl. G06F 3/038

(52) U.S. Cl. CPC G06F 3/0383
USPC 345/177

(57) ABSTRACT

Provided is an information input apparatus using an ultrasonic signal according to the present invention, a connector which is to be inserted into a communication port of a portable electronic apparatus is installed in a position measurement module which measures a position of a signal generation device to generate position information of the signal generation device by receiving an ultrasonic signal, and a connector connection member which is to be connected to the connector is installed in a docking module which is detachably fixed to a handwriting surface to store the position information of the signal generation device therein and to transmit the position information to an external electronic apparatus. Therefore, the connector of the position measurement module is inserted into a connector connection member of the docking module, so that the position measurement module and the docking module can be easily coupled with and detached from each other.

### BACKGROUND OF THE INVENTION

1. Field of the Invention

The present invention relates to an information input apparatus, and more particularly to, an information input apparatus using an ultrasonic signal.

2. Description of the Related Art

As information and communication technology has been developed, various types of information input apparatuses have been commercialized as a substitute for substituting for an information input apparatus such as a keyboard and a mouse generally used for an electronic apparatus such as a computer in the related art.

As information input apparatuses recently having drawn attention, there are a touch panel where a user directly touches a screen of an electronic apparatus with a finger to input information and an information input apparatus using an electronic pen where an ultrasonic signal generated by the electronic pen is used to input position information of the electronic pen. An example of the information input apparatus using the electronic pen is disclosed in Korean Patent Application Publication No. 10-0418423, registered on Jan. 31, 2004.

In the information input apparatus using an ultrasonic signal in the related art, there is inconvenience in that a user needs to directly install an ultrasonic receiving sensor in an outer portion of the electronic apparatus. Therefore, in another information input apparatus using an ultrasonic signal in the related art, the ultrasonic sensor and the like are installed within a housing and the housing is connected to the electronic apparatus through a USB cable, so that the above problem is solved.

Since the information input apparatus using the ultrasonic signal is connected to the electronic apparatus through the USB cable, the information input apparatus is convenient to use in a fixed site such as an office. However, in the case where the information input apparatus coupled with a portable electronic apparatus is to be used during movement, there is still inconvenience. In addition, in order to input content of handwriting performed on a notebook in a digital manner, there is inconvenience in that the information input apparatus always needs to be in connection to the external electronic apparatus.

### SUMMARY OF THE INVENTION

The present invention is to provide an information input apparatus using an ultrasonic signal capable of being coupled with a portable electronic apparatus and performing information inputting during movement and capable of performing inputting even in a state where the information input apparatus is not connected to a portable electronic apparatus or an external electronic apparatus.

According to an aspect of the present invention, there is provided an information input apparatus including: a position measurement module which receives an ultrasonic signal and a reference signal generated by a signal generation device so at to measure a position of the signal generation device and generate position information or so as to generate information for position measurement; and a docking module which is detachably fixed to a handwriting surface where the signal generation device is moved and is detachably coupled with the position measurement module.

In the above aspect, the position measurement module may include a connector which is to be connected to a portable electronic apparatus, and the docking module may include a connector connection member corresponding to the connector so that the docking module can be coupled with or detached from the position measurement module.

In addition, in the above aspect, in a state where the connector is connected to the portable electronic apparatus, the position measurement module may generate the position information of the signal generation device or the information for position measurement of the signal generation device which is moved on a screen or a handwriting surface of the portable electronic apparatus to output the position information or the information for position measurement through the connector to the portable electronic apparatus.

In addition, in the above aspect, in a state where the connector is connected to the connector connection member so that the position measurement module is coupled with the docking module, the position measurement module may generate the position information of the signal generation device or the information for position measurement of the signal generation device which is moved on a handwriting surface to output the position information or the information for position measurement through the connector to the docking module.

In addition, in the above aspect, the docking module may include a connection cable which is to connects the connector connection member to an external electronic apparatus so that the position measurement module can be directly supplied with power from the external electronic apparatus and can directly output the position information or the information for position measurement to the external electronic apparatus.

In addition, in the above aspect, the docking module may include: a docking housing; a fixing member which is attached to the docking housing so that the docking housing can be fixed to the handwriting surface; the connector connection member which is installed within the docking housing so that the position measurement module can be coupled with the docking housing by connecting the connector of the position measurement module to the connector connection member; and the connection cable which connects the connector connection member and the external electronic apparatus.

In addition, in the above aspect, the docking module may include: a memory unit which stores the position information or the information for position measurement received from the position measurement module; a communication unit which transmits the position information or the information for position measurement in a wired or wireless communication manner; and a power supply unit which supplies power to the position measurement module.

In addition, in the above aspect, the docking module may include: a docking housing which accommodates the memory unit, the communication unit, and the power supply unit therein; a fixing member which is attached to the docking housing so that the docking housing can be fixed to the handwriting surface; and the connector connection member which is installed within the docking housing so that the position measurement module can be coupled with the docking housing by connecting the connector of the position measurement module to the connector connection member.

In addition, in the above aspect, the fixing member may be attached to the docking housing with a hinge and the one end of the fixing member is in contact with the docking housing due to an elastic member, or the one end of the fixing member is integrally attached to the docking housing and the other end of the fixing member is in contact with the docking housing.

In addition, in the above aspect, the position measurement module may include: a plurality of ultrasonic signal reception units which are separated from each other to receive the ultrasonic signal generated by the signal generation device; a reference signal reception unit which receives the reference signal generated by the signal generation device; a position measurement unit which measures the position of the signal generation device to generate the position information by using a time difference between a reception time of the ultrasonic signal and a reception time of the reference signal or generates the information for position measurement by using the time difference; and the connector which is connected to the portable electronic apparatus and the docking module.

In an information input apparatus using an ultrasonic signal according to the present invention, a connector which is to be inserted into a communication port of a portable electronic apparatus is installed in a position measurement module which measures a position of a signal generation device to generate position information of the signal generation device by receiving an ultrasonic signal or generates an information for position measurement of the signal generation device by receiving an ultrasonic signal, and a connector connection member which is to be connected to the connector is installed in a docking module which is detachably fixed to a handwriting surface to store the position information of the signal generation device or the information for position measurement of the signal generation device therein and to transmit the position information or the information for position measurement to an external electronic apparatus. Therefore, the connector of the position measurement module is inserted into a connector connection member of the docking module, so that the position measurement module and the docking module can be easily coupled with and detached from each other.

In addition, the position measurement module detached from the docking module can be easily coupled with the portable electronic apparatus by directly inserting the connector into the communication port such as a USB port of the portable electronic apparatus.

In this manner, since the position measurement module can be easily coupled with or detached from the docking module and the portable electronic apparatus, according to a situation, a user can couple the position measurement module with the portable electronic apparatus and move the signal generation device on a screen of the portable electronic apparatus to directly input information in the portable electronic apparatus, or the user can couple the position measurement module with the docking module fixed to the handwriting surface to store the position information or the information for position measurement in the docking module. In addition, when the external electronic apparatus and the docking module are connected to each other, the information stored in the docking can be transmitted to the external electronic apparatus.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a configuration of an information input apparatus using an ultrasonic signal according to an exemplary first embodiment of the present invention;

FIG. 2 is a diagram illustrating an example of a position measurement module according to the exemplary first embodiment of the present invention;

FIG. 3 is a diagram illustrating an example of a docking module according to the exemplary first embodiment of the present invention;

FIGS. 4A to 4C are diagrams illustrating an example of inputting information by using the information input apparatus according to the exemplary first embodiment of the present invention; and

FIG. 5 is a block diagram illustrating a configuration of an information input apparatus using an ultrasonic signal according to an exemplary second embodiment of the present invention.

### DETAILED DESCRIPTION OF THE INVENTION

Hereinafter, exemplary embodiments of the present invention will be described with reference to the attached drawings.

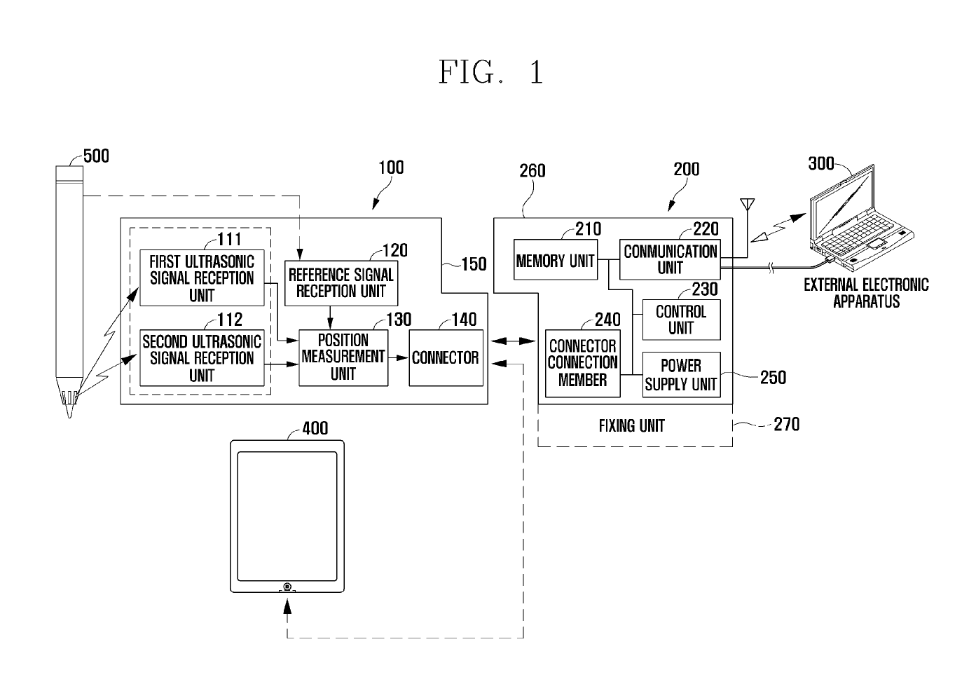

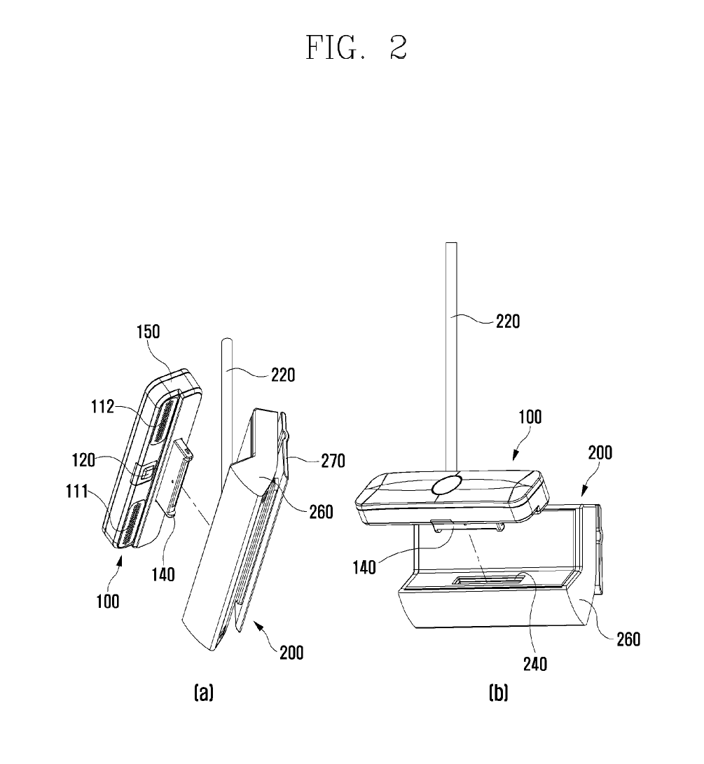

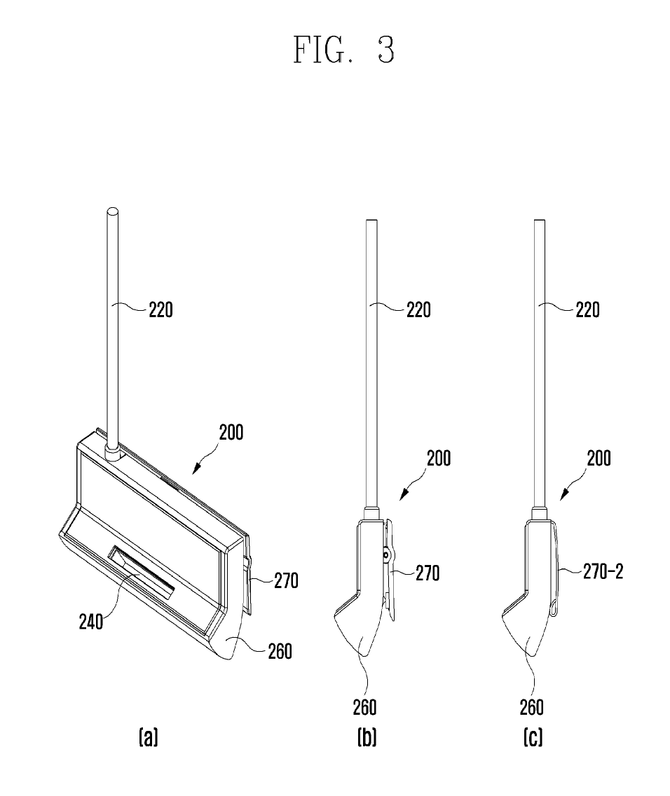

FIG. 1 is a block diagram illustrating a configuration of an information input apparatus using an ultrasonic signal according to an exemplary first embodiment of the present invention. FIG. 2 is a diagram illustrating an example of a position measurement module 100 according to the exemplary first embodiment of the present invention. FIG. 3 is a diagram illustrating an example of a docking module 200 according to the exemplary first embodiment of the present invention.

The information input apparatus using an ultrasonic signal (hereinafter, simply referred to as an “information input apparatus”) according to the exemplary first embodiment of the present invention will be described with reference to FIGS. 1 to 3.

As described above, the information input apparatus according to the present invention is configured to include a position measurement module 100 and a docking module 200.

The position measurement module 100 receives an ultrasonic signal and a reference signal generated by a signal generation device 500 and measures a position of the signal generation device 500 to generate position information through the triangulation method by using a time difference between a reception time of the reference signal and a reception time of the ultrasonic signal. In addition, in some cases, the position measurement module 100 generates information (for example, a distance between the signal generation device 500 and each ultrasonic signal reception unit, a time difference between the reception time of the reference signal and the ultrasonic signal in each ultrasonic signal reception unit, or the like) (hereinafter, simply referred to as “information for position measurement”) used for measurement of the position of the signal generation device 500.

The position measurement module 100 transmits the position information of the signal generation device 500 or the information for position measurement of the signal generation device 500 to a portable electronic apparatus 400 or a docking module 200 according to a coupling state.

The docking module 200 is detachably fixed to a handwriting surface, for example, a notebook where the signal generation device 500 is moved, and the position measurement module 100 is detachably coupled with the docking module 200. In the coupling state, the docking module 200 receives the position information of the signal generation device 500 from the position measurement module 100 and stores the position information in an internal memory. When the docking module 200 is connected to an external electronic apparatus 300, the docking module 200 transmits the stored position information to the external electronic apparatus 300 or transmits the position information received from the position measurement module 100 to the external electronic apparatus 300 in real time.

The configurations of the position measurement module 100 and the docking module 200 will be described in detail with reference to FIGS. 1 and 2. First, the position measurement module 100 is configured to include a plurality of ultrasonic signal reception units 111 and 112, a reference signal reception unit 120, a connector 140, and a position measurement unit 130, and these components are installed within a housing 150 (refer to (a) and (b) of FIG. 2)

The ultrasonic signal reception units 111 and 112 are installed on the housing 150 to be separated from each other by a predefined distance to receive the ultrasonic signal from the signal generation device 500.

The reference signal reception unit 120 is installed in the housing 150 to receive the reference signal. The connector 140 is installed in the housing 500 so as to be connected to a communication port installed in the portable electronic apparatus 400.

The position measurement unit 130 is installed in the housing 150 so as to measure the position of the signal generation device 500 to generate the position information by using the reception time of the ultrasonic signal generated by the signal generation device 500 in each of the ultrasonic signal reception units 111 and 112 and the reception time of the reference signal generated by the signal generation device 500 in the reference signal reception unit 120 or so as to generate the information for position measurement such as distance information or time difference information used for measurement of the position of the signal generation device 500 by using the reception time of the ultrasonic signal and the reception time of the reference signal.

Since a method of measuring the position of the signal generation device 500 is described in detail in the above-mentioned Korean Patent Application Publication No. 10-0418423, the method will be described in brief. When a user performs information inputting, for example, handwriting by using the signal generation device 500 implemented as an electronic pen, the signal generation device 500 generates the reference signal and the ultrasonic signal simultaneously in a predetermined time period.

Since the reference signal which is implemented by an RF signal, an infrared ray signal, or the like propagating at the speed of light can be treated to be received by the reference signal reception unit 120 at the same time of the generation, the reception time of the reference signal is used as the generation time of the ultrasonic signal.

In addition, the time difference between the reception time of the reference signal and the reception time of the ultrasonic signal in each of the ultrasonic signal reception units 111 and 112 is equal to the time taken for the ultrasonic signal to propagate from the signal generation device 500 to each of the ultrasonic signal reception units 111 and 112, the distance from the signal generation device 500 and each of the ultrasonic signal reception units 111 and 112 can be obtained by multiplying the time difference with the speed of sound. In addition, since the distance between the ultrasonic signal reception units 111 and 112 is a predefined distance, the position of the signal generation device 500 can be measured through the triangulation method by using these distances.

On the other hand, the docking module 200 is configured to include a memory unit 210, a power supply unit 250, a connector connection member 240, a communication unit 220, a docking housing 260, a fixing member 270, and a control unit 230. Among these components, the memory unit 210, the power supply unit 250, the communication unit 220, and the control unit 230 are installed within the docking housing 260. The connector connection member 240 is installed on the docking housing 260 so as to be coupled with the connector 140 of the position measurement module 100.

The fixing member 270 is attached with the docking housing 260 so that the docking housing 260 can be easily detachably fixed to a handwriting surface such as a notebook or a paper. In the example illustrated in (a) and (b) FIG. 3, the fixing member 270 is attached to the docking housing 260 with a hinge, and the one end of the fixing member 270 is in contact with the docking housing 260 due to an elastic member interposed between the fixing member 270 and the docking housing 260.

In another example illustrated in (c) of FIG. 3, a fixing member 270-2 may be configured as a form of a clip so that the one end of the fixing member 270-2 is integrally attached to the docking housing 260 and the other end of the fixing member 270-2 is in contact with the outer surface of the docking housing 260. In this example, the contact area of the docking housing 260 and the fixing member 270 is fixed to an edge region of the handwriting surface.

When the position measurement module 100 is coupled with the docking module 200 by connecting the connector 140 of the position measurement module 100 to the connector connection member 240, the power supplying unit 250 of the docking module 200 supplies power to the position measurement module 100. The power supply unit 250 may be implemented by using a general battery, a secondary battery, or the like.

The memory unit 210 stores the position information of the signal generation device 500 or the information for position measurement of the signal generation device 500 received from the position measurement module 100. Under the control of the control unit 230, the memory unit 210 outputs the stored position information or information for position measurement to the communication unit 220.

The communication unit 220 communicates with the external electronic apparatus 300 in a wireless communication manner using Bluetooth, Zigbee, or RF communication or in a wired communication manner using a USB cable to transmit the position information or information for position measurement stored in the memory unit 210 to the external electronic apparatus 300 or to transmit the position information or information for position measurement, which is input from the position measurement module 100 through the connector connection member 240 in real time, to the external electronic apparatus 300.

The control unit 230 controls functions of the above-described components. When the connector 140 of the position measurement module 100 is connected to the connector connection member 240, the control unit 230 communicates with the position measurement module 100 in a predetermined communication manner to allow the position information or information for position measurement input from the position measurement module 100 to be stored in the memory unit 210 or to allow the position information or information for position measurement to be transmitted through the communication unit 220 to the external electronic apparatus 300.

In the case where the external electronic apparatus 300 receives the position information from the docking module 200, the external electronic apparatus 300 stores the position information in an internal memory thereof or displays the position information in real time. In the case where the external electronic apparatus 300 receives the information for position measurement, the external electronic apparatus 300 generates the position information of the signal generation device 500 by using the information for position measurement and, after that, stores the position information or displays the position information in real time.

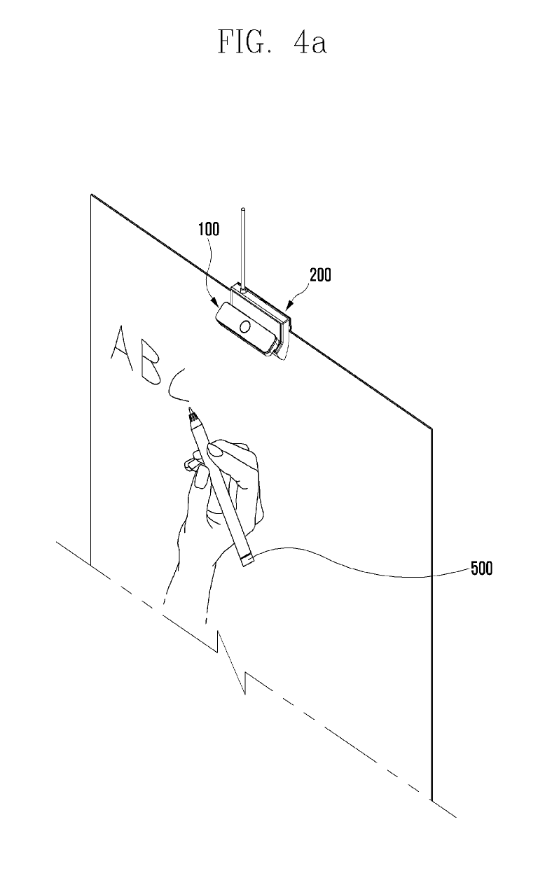

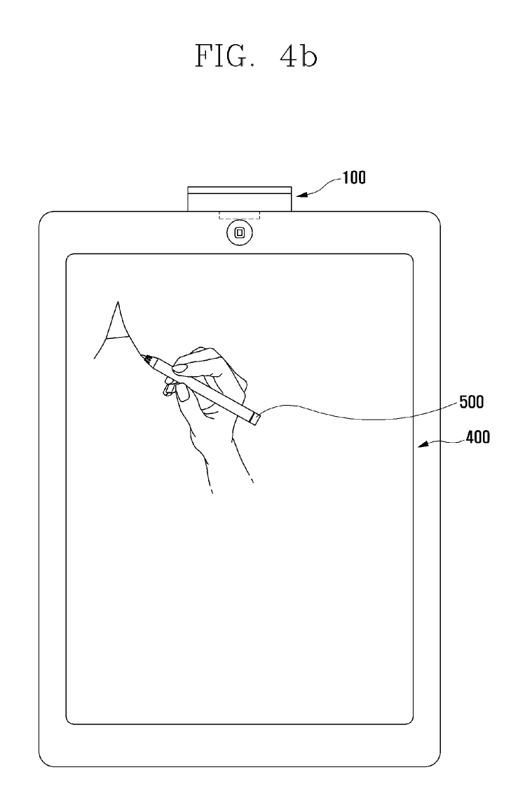

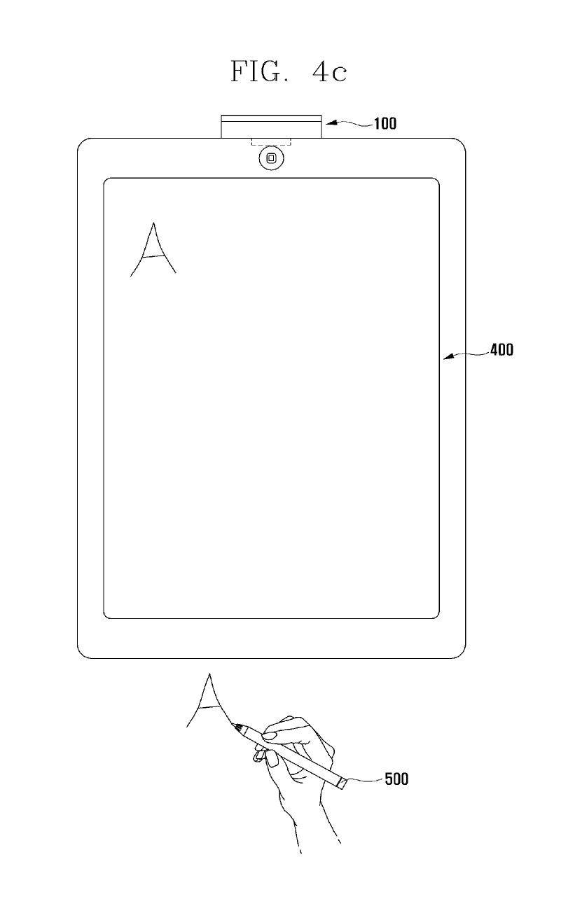

Hereinbefore, the configuration of the information input apparatus using an ultrasonic signal according to the exemplary first embodiment of the present invention was described. FIGS. 4A and 4B are diagrams illustrating examples of information inputting by using the information input apparatus according to the exemplary first embodiment of the present invention.

In the example illustrated in FIG. 4A, in the state where the position measurement module 100 is coupled with the docking module 200, a user inserts a paper or a notebook between the docking housing 260 and the fixing member 270. Next, when the user performs handwriting on the handwriting surface of the paper or notebook by using the signal generation device 500 added with a pen core for ink handwriting, the position measurement module 100 generates the position information of the signal generation device 500 or the information for position measurement of the signal generation device 500. The generated position information or information for position measurement is stored in the memory unit 210 of the docking module 200. As described above, the position information stored in the memory unit 210 may be transmitted to the external electronic apparatus 300.

In the example illustrated in FIG. 4B, when the user detaches the position measurement module 100 from the docking module 200 and inserts the position measurement module 100 into the communication port of the portable electronic apparatus 400, power is supplied from the portable electronic apparatus 400 to the position measurement module 100, so that the position measurement module 100 is driven. Next, when the user moves the signal generation device 500 on a screen of the portable electronic apparatus 400, the position measurement module 100 measures the position of the signal generation device 500 and transmits the position information to the portable electronic apparatus 400. The portable electronic apparatus 400 may display the position information on the screen thereof. On the other hand, when the position measurement module 100 transmits the information for position measurement to the portable electronic apparatus 400, the portable electronic apparatus 400 measures the position of the signal generation device 500 and displays the position of the signal generation device 500 on the screen thereof.

Similarly to FIG. 4B, in the example illustrated in FIG. 4C, in the state where the position measurement module 100 is inserted into the communication port of the portable electronic apparatus 400, if the user moves the signal generation device 500 on an external area (handwriting surface) of the portable electronic apparatus 400, the position measurement module 100 transmits the position information of the signal generation device 500 or the information for position measurement of the signal generation device 500 to the portable electronic apparatus 400, and the portable electronic apparatus 400 displays the position information at the position on the screen corresponding to the external area.

Hereinbefore, the information input apparatus using an ultrasonic signal according to the exemplary first embodiment of the present invention was described.

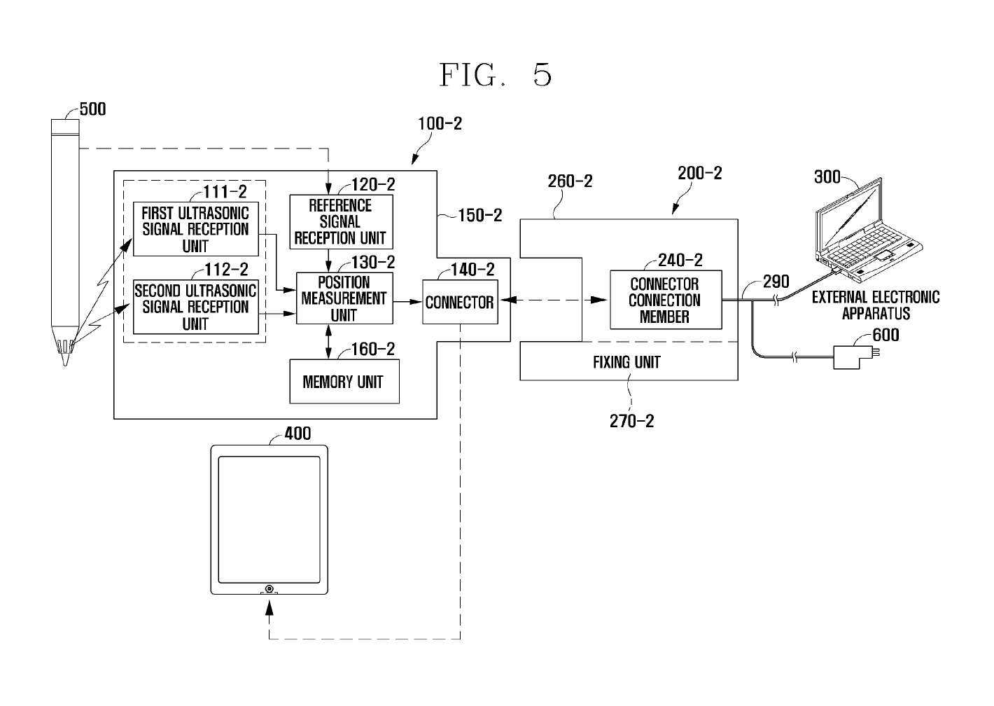

FIG. 5 is a block diagram illustrating a configuration of an information input apparatus using an ultrasonic signal according to an exemplary second embodiment of the present invention.

Similarly to the first embodiment, the information input apparatus according to the second embodiment of the present invention is also configured to include a position measurement module 100-2 and a docking module 200-2, and the outer appearance thereof is the same as that of the first embodiment.

The docking module 200-2 includes a connector connection member 240-2, which a connecter 140-2 of the position measurement module 100-2 is to be connected to, within a docking housing 260-2, and a connection cable 290 which connects the connector connection member 240-2 and an external electronic apparatus 300 or an external power supply device (600; for example, power supply adaptor) is extended from the connector connection member 240-2 to an external apparatus outside the docking housing 260-2. In addition, a fixing member 270-2 is coupled with the docking housing 260-2 in the same manner as that of the first embodiment.

The docking module 200-2 basically performs a function of fixing the position measurement module 100-2 to a handwriting surface. In addition, in the case where the connection cable 290 is connected to the external electronic apparatus 300, the docking module 200-2 supplies power supplied from the external electronic apparatus 300 to the position measurement module 100-2 and implements a wired communication line between the position measurement module 100-2 and the external electronic apparatus 300. In addition, in the case where the connection cable 290 is connected to an external power supply device 600, the docking module 200-2 functions as a power connection line of connecting the external power supply device 600 and the position measurement module 100-2.

The position measurement module 100-2 is configured to include a plurality of ultrasonic signal reception units 111-2 and 112-2, a reference signal reception unit 120-2, a position measurement unit 130-2, a connector 140-2, and a memory unit 160-2. In the case where the external electronic apparatus 300 such as a personal computer (PC) is connected to the docking module 200-2, since the position information or information for position measurement output from the position measurement module 100-2 may be stored in the external electronic apparatus 300, the memory unit 160-2 of the position measurement module 100-2 may be omitted.

The position measurement unit 130-2 measures the position of the signal generation device 500 by using the time difference between the reception time of the reference signal in the reference signal reception unit 120-2 and the reception time of the ultrasonic signal in each of the ultrasonic signal reception units 111-2 and 112-2 to store the position information of the signal generation device 500 in the memory unit 160-2 or transmit the position information of the signal generation device 500 to the external electronic apparatus 300 in real time in the case where the external electronic apparatus 300 is connected. In addition, the position information stored in the memory unit 160-2 may be transmitted to the external electronic apparatus 300 in the external electronic apparatus 300 is connected.

In addition, similarly to the first embodiment, the position measurement unit 130-2 may generate only the information for position measurement to store the information for position measurement in the memory unit 160-2 or transmit the information for position measurement to the external electronic apparatus 300.

Since the functions of the ultrasonic signal reception units 111-2 and 112-2, the reference signal reception unit 120-2, and the connector 140-2 of the position measurement module 100-2 are the same as those of the first embodiment, detailed description thereof is omitted.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An information input apparatus comprising:
a position measurement module which receives an ultrasonic signal and a reference signal generated by a signal generation device so as to measure a position of the signal generation device and generate position information or so as to generate information for position measurement; and
a docking module which is detachably fixed to a handwriting surface where the signal generation device is moved and is detachably coupled with the position measurement module.

2. The information input apparatus according to claim 1,
wherein the position measurement module includes a connector which is to be connected to a portable electronic apparatus, and
wherein the docking module includes a connector connection member corresponding to the connector so that the docking module can be coupled with or detached from the position measurement module.

3. The information input apparatus according to claim 2, wherein the docking module includes a connection cable which is to connects the connector connection member to an external electronic apparatus so that the position measurement module can be directly supplied with power from the external electronic apparatus and can directly output the position information or the information for position measurement to the external electronic apparatus.

4. The information input apparatus according to claim 3, wherein the docking module includes:
a docking housing;
a fixing member which is attached to the docking housing so that the docking housing can be fixed to the handwriting surface;
the connector connection member which is installed within the docking housing so that the position measurement module can be coupled with the docking housing by connecting the connector of the position measurement module to the connector connection member; and
the connection cable which connects the connector connection member and the external electronic apparatus.

5. The information input apparatus according to claim 2, wherein the docking module includes:
a memory unit which stores the position information or the information for position measurement received from the position measurement module;
a communication unit which transmits the position information or the information for position measurement in a wired or wireless communication manner; and
a power supply unit which supplies power to the position measurement module.

6. The information input apparatus according to claim 5, wherein the docking module further includes:
a docking housing which accommodates the memory unit, the communication unit, and the power supply unit therein;
a fixing member which is attached to the docking housing so that the docking housing can be fixed to the handwriting surface; and
the connector connection member which is installed within the docking housing so that the position measurement module can be coupled with the docking housing by connecting the connector of the position measurement module to the connector connection member.

7. The information input apparatus according to claim 6, wherein the fixing member is attached to the docking housing with a hinge and the one end of the fixing member is in contact with the docking housing due to an elastic member, or the one end of the fixing member is integrally attached to the docking housing and the other end of the fixing member is in contact with the docking housing.

8. The information input apparatus according to claim 2, wherein the position measurement module includes:
a plurality of ultrasonic signal reception units which are separated from each other to receive the ultrasonic signal generated by the signal generation device;
a reference signal reception unit which receives the reference signal generated by the signal generation device;
a position measurement unit which measures the position of the signal generation device to generate the position information by using a time difference between a reception time of the ultrasonic signal and a reception time of the reference signal or generates the information for position measurement by using the time difference; and
the connector which is connected to the portable electronic apparatus and the docking module.

9. The information input apparatus according to claim 2, wherein in a state where the connector is connected to the portable electronic apparatus, the position measurement module generates the position information of the signal generation device or the information for position measurement of the signal generation device which is moved on a screen or a handwriting surface of the portable electronic apparatus to output the position information or the information for position measurement through the connector to the portable electronic apparatus.

10. The information input apparatus according to claim 9, wherein the docking module includes a connection cable which is to connects the connector connection member to an external electronic apparatus so that the position measurement module can be directly supplied with power from the external electronic apparatus and can directly output the position information or the information for position measurement to the external electronic apparatus.

11. The information input apparatus according to claim 10, wherein the docking module includes:
a docking housing;
a fixing member which is attached to the docking housing so that the docking housing can be fixed to the handwriting surface;
the connector connection member which is installed within the docking housing so that the position measurement module can be coupled with the docking housing by connecting the connector of the position measurement module to the connector connection member; and
the connection cable which connects the connector connection member and the external electronic apparatus.

12. The information input apparatus according to claim 9, wherein the docking module includes:
a memory unit which stores the position information or the information for position measurement received from the position measurement module;
a communication unit which transmits the position information or the information for position measurement in a wired or wireless communication manner; and
a power supply unit which supplies power to the position measurement module.

13. The information input apparatus according to claim 12, wherein the docking module further includes:
a docking housing which accommodates the memory unit, the communication unit, and the power supply unit therein;
a fixing member which is attached to the docking housing so that the docking housing can be fixed to the handwriting surface; and
the connector connection member which is installed within the docking housing so that the position measurement module can be coupled with the docking housing by connecting the connector of the position measurement module to the connector connection member.

14. The information input apparatus according to claim 9, wherein the position measurement module includes:
a plurality of ultrasonic signal reception units which are separated from each other to receive the ultrasonic signal generated by the signal generation device;
a reference signal reception unit which receives the reference signal generated by the signal generation device;
a position measurement unit which measures the position of the signal generation device to generate the position information by using a time difference between a reception time of the ultrasonic signal and a reception time of the reference signal or generates the information for position measurement by using the time difference; and
the connector which is connected to the portable electronic apparatus and the docking module.

15. The information input apparatus according to claim 2, wherein in a state where the connector is connected to the connector connection member so that the position measurement module is coupled with the docking module, the position measurement module generates the position information of the signal generation device or the information for position measurement of the signal generation device which is moved on a handwriting surface to output the position information or the information for position measurement through the connector to the docking module.

16. The information input apparatus according to claim 15, wherein the docking module includes a connection cable which is to connects the connector connection member to an external electronic apparatus so that the position measurement module can be directly supplied with power from the external electronic apparatus and can directly output the position information or the information for position measurement to the external electronic apparatus.

17. The information input apparatus according to claim 16, wherein the docking module includes:
a docking housing;
a fixing member which is attached to the docking housing so that the docking housing can be fixed to the handwriting surface;
the connector connection member which is installed within the docking housing so that the position measurement module can be coupled with the docking housing by connecting the connector of the position measurement module to the connector connection member; and
the connection cable which connects the connector connection member and the external electronic apparatus.

18. The information input apparatus according to claim 15, wherein the docking module includes:
a memory unit which stores the position information or the information for position measurement received from the position measurement module;
a communication unit which transmits the position information or the information for position measurement in a wired or wireless communication manner; and
a power supply unit which supplies power to the position measurement module.

19. The information input apparatus according to claim 18, wherein the docking module further includes:
a docking housing which accommodates the memory unit, the communication unit, and the power supply unit therein;
a fixing member which is attached to the docking housing so that the docking housing can be fixed to the handwriting surface; and
the connector connection member which is installed within the docking housing so that the position measurement module can be coupled with the docking housing by connecting the connector of the position measurement module to the connector connection member.

20. The information input apparatus according to claim 15, wherein the position measurement module includes:
a plurality of ultrasonic signal reception units which are separated from each other to receive the ultrasonic signal generated by the signal generation device;
a reference signal reception unit which receives the reference signal generated by the signal generation device;
a position measurement unit which measures the position of the signal generation device to generate the position information by using a time difference between a reception time of the ultrasonic signal and a reception time of the reference signal or generates the information for position measurement by using the time difference; and
the connector which is connected to the portable electronic apparatus and the docking module.
